(19) United States
(12) Patent Application Publication
(10) Pub. No.: US 2010/0002238 A1
(43) Pub. Date: Jan. 7, 2010

(54) LASER INTERFERENCE DEVICE FOR TOUCH SCREENS

(75) Inventors: Cristian Presura, Veldhoven (NL); Gary Nelson Garcia Molina, Eindhoven (NL); Galileo June Destura, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/444,706

(22) PCT Filed: Oct. 9, 2007
(86) PCT No.: PCT/IB07/54107

§ 371 Date: Apr. 8, 2009

Related U.S. Application Data
(60) Provisional application No. 60/829,004, filed on Oct. 11, 2006.

(51) Int. Cl. G01B 9/02

(52) U.S. Cl. 356/450

(57) ABSTRACT

A system and method for location determination by laser interference detection uses a wide beamwidth laser projection (301) across a planar area (300). A lens system (222) is used to provide the wide beamwidth projection, and a split-beam system (225) is used to correlate interference patterns to particular segments of the wide beamwidth projection. The reflected interference beams are detected on a detector array (240) that is configured to detect the undulations corresponding to objects within the wide beamwidth projection.

This invention relates to the field of touch devices, and in particular to a touch device that uses laser interference measurements to detect touch locations on a surface.

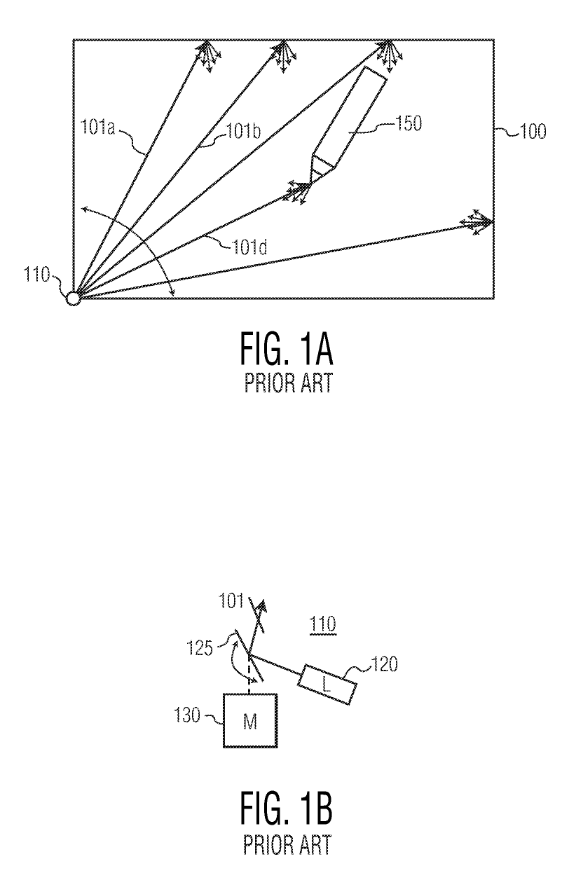

U.S. Pat. No. 6,816,537 “DEVICE HAVING TOUCH SENSITIVITY FUNCTIONALITY”, issued 9 Nov. 2004 to Martin D. Liess, and incorporated by reference herein, discloses a touch screen that uses laser interference/reflection to detect the location of an object, such as a stylus or finger, that is touching the screen. FIGS. 1A and 1B illustrate the techniques used in this patent. FIG. 1B illustrates a scanning device 110 that includes a laser emitting and detecting device 120 that provides a laser beam 101. The laser beam 101 is reflected from a mirror 125 that oscillates under control of a mechanism 130. References 101a, 101b, etc., in FIG. 1A are used to indicate this beam at different instances of time as the beam is swept across the surface of the screen 100.

If there is no obstruction to the path of the beam 101, the beam travels to the edge of the screen 100 and reflects off the edge in a scattered pattern. Using techniques common to the art of laser detection, the scattered rays that are reflected back to the scanning device 110 introduce interference that produces undulations to the light output of the laser emitting diode of the device 120, and the resultant current modulation is detected by the detector of the laser emitting and detecting device 120. Based on the relative time of occurrence of the undulation and the angle of the mirror 125, the distance and direction to the source of the reflection can be determined, respectively. In this manner, the occurrence of an object 150 upon the surface of the screen will introduce an undulation from which its distance and direction can be determined. Reflections from the edges of the screen 100 provide a regular set of undulations from which the system can be calibrated.

Although this prior art system provides an effective means for detecting objects that touch a surface of a screen or otherwise intersect the planar projection of the beam 101, the mechanical nature of providing the planar projection is problematic. Being mechanical, its use may be limited to particular environments, and the reliability of the system will likely be limited to the reliability of the mechanical structure. In like manner, the cost and complexity of manufacture will likely be substantially dependent upon this mechanical device.

Additionally, the scanning of the surface consumes time, and a substantial amount of ‘dead time’ occurs between scans of any given point/ray on the surface. To accurately capture movement on a surface, such as the movement of a stylus as a person writes on the surface, at least 30 samples per second are generally required, which may not be realizable and/or practical using a mechanical scanning structure.

It would be advantageous to provide a touch screen that includes few, if any, moving parts. It would also be advantageous to provide a touch screen that can be produced relatively inexpensively. It would also be advantageous to provide a cost effective method of laser interference based location detection. It would also be advantageous to provide a touch screen that provides a rapid rate of location determination.

These advantages, and others, can be realized by a system and method for location determination by laser interference detection that uses a wide beamwidth laser projection across a planar area. A lens system is used to provide the wide beamwidth projection, and a split-beam system is used to correlate interference patterns to particular segments of the wide beamwidth projection. The reflected interference beams are detected on a detector array that is configured to detect the undulations corresponding to objects within the wide beamwidth projection. Because the beam does not scan the surface, per se, the speed of sampling is limited only by the time required to sample and process the output of the array of detectors.

In a preferred embodiment, the invention includes a system that comprises a source of a wide beamwidth projection, an array of detectors, a beam splitter that is configured to provide two projections of the wide beamwidth projection: a first projection that extends across a planar area, and a second projection that extends across the array of detectors, and a detection system that is configured to detect interferences caused by reflections of the first projection onto the array of detectors, and to determine therefrom a presence of one or more objects in the planar area.

Preferably, a method of this invention includes providing a wide beamwidth projection; splitting the wide beamwidth projection to provide two projections: a first projection that extends across a planar area, and a second projection that extends across an array of detectors; detecting interferences caused by reflections of the first projection onto the array of detectors; and determining from the interferences a presence of one or more objects in the planar area.

The invention is explained in further detail, and by way of example, with reference to the accompanying drawings wherein:

FIGS. 1A and 1B illustrate example block diagrams of a prior art laser interference detection device.

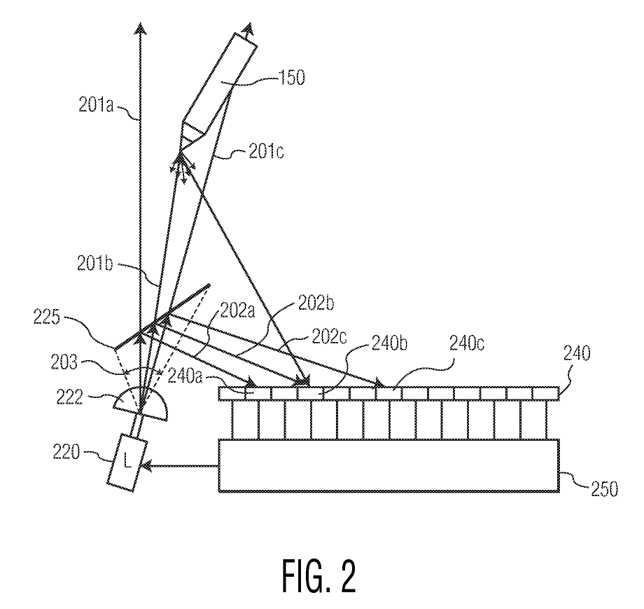

FIG. 2 illustrates an example block diagram of a laser interference detection device in accordance with this invention.

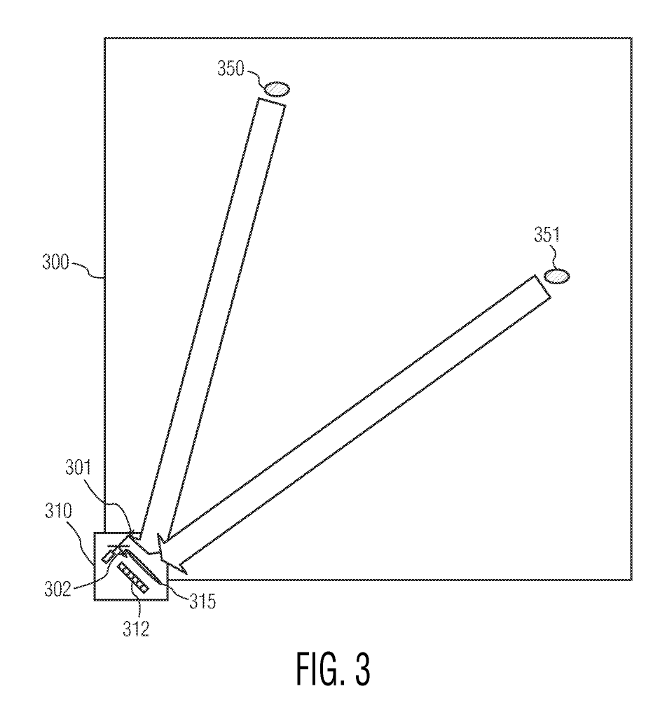

FIG. 3 illustrates an example block diagram of a laser interference device touch screen device in accordance with this invention.

Throughout the drawings, the same reference numeral refers to the same element, or an element that performs substantially the same function. The drawings are included for illustrative purposes and are not intended to limit the scope of the invention.

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments, which depart from these specific details. For purposes of simplicity and clarity, detailed descriptions of well-known devices, circuits, and methods are omitted so as not to obscure the description of the present invention with unnecessary detail.

FIG. 2 illustrates an example block diagram of a laser interference detection device in accordance with this invention. The device includes a laser emitter 220 and a lens 222 that are configured to provide a wide beamwidth laser projection 203. A beam-splitting device 225, such as a semi-transparent mirror, splits the projection 203 into a first projection that extends into a planar area beyond the device 225, and a second projection that extends across an array of detectors 240. Sample beams within the first projection are illustrated as beams 201a-c, and within the second projection as 202a-c.

The splitter 225 is arranged such that each beam within the second projection strikes the array of detectors 240 at a different point along the array. Each beam provides a first component that travels through the planar area at a particular angle relative to the source of the beam, and a second component that strikes a particular point along the array 240. Thus, each point along the array 240 corresponds to a projection angle of the beam across the planar area. That is, for example, beams 202a, 202b, 202c, and interference to these beams, will be detectable at detector segments 240a, 240b, 240c, respectively. When an object 150 scatters beam 201b, the reflections from the object 150 that reach the array 240 will introduce interference to the corresponding beam 202b at detector 240b. As detailed further below, an imaging lens system is preferably used to direct the reflected beams 202a-c to their corresponding detectors 240a-c, to further enhance the induced interference modulations.

A detection system 250 processes the detected interference patterns to determine the location of the object 150 within the planar area, using conventional laser interference techniques, such as those disclosed in the aforementioned U.S. Pat. No. 6,816,537. As in this prior art patent, the distance of the object from the source of the laser emission can be determined based on the relative time-delay of the interference. In this application, however, the angle of the object from the laser source is determined based on the location of the detected interference along the array 240. In a preferred embodiment, the detection system 250 is configured to control the laser emission system to provide an appropriate energy level to facilitate reliable object detection.

The accuracy and resolution of the detection system 250 will be dependent upon the detection resolution of the array 240. Fewer detectors in the array 240 will provide lesser resolution, although known techniques may be used to provide a higher effective resolution. Depending upon the relative geometries of the detectors in the array 240 and the size of the object 150, the interference may extend across multiple detectors, and conventional centroid-determining filter or interpolation techniques may be used to refine the accuracy and precision of the determined angle of the object 150 relative to the emitting source. In like manner, multiple samples over time may be used to further refine the accuracy and precision of both the distance and angle measurements.

A variety of lens systems may also be employed to form or reform the projections. In a preferred embodiment, a cylindrical lens is used to provide a wide beamwidth projection, and other lenses may be used to further direct this projection to the planar area. In like manner, a lens system may be used to direct the reflections from the planar area to the detector array 240.

FIG. 3 illustrates an example touch screen embodiment of this invention. A display screen 300 includes a laser interference detector 310 that uses a wide beamwidth projection that is split into a first projection 301 that extends across the screen area, and a second projection 302 that extends across an array of detectors 312. A lens system 315 serves to direct reflections from objects 350, 351 to the detectors 312. Provided that the objects 350, 351 are not at the same angle from the detector 310, the interference patterns from the objects 350 and 351 will be distinguishable, and the associated detection system will be able to report the occurrence of these two objects in proximity and/or contact with the screen 300. In a preferred embodiment, the lens system 315 is configured to direct reflections arriving at different angles to the areas on the array 312 corresponding to these angles of the projected beams.

The foregoing merely illustrates the principles of the invention. It will thus be appreciated that those skilled in the art will be able to devise various arrangements which, although not explicitly described or shown herein, embody the principles of the invention and are thus within its spirit and scope. For example, although the invention is presented in the context of a laser interference system that is configured to detect the location of objects, the principles of this invention may be applied to other projection systems, and may be applied to other detection schemes, such as a simple direction detector that does not per se determine distance, or a simple proximity detector that merely detects the presence of an object within the field of a wide beamwidth projection. These and other system configuration and optimization features will be evident to one of ordinary skill in the art in view of this disclosure, and are included within the scope of the following claims.

In interpreting these claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) each of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices or portions thereof may be combined together or separated into further portions unless specifically stated otherwise;
h) no specific sequence of acts is intended to be required unless specifically indicated; and
i) the term “plurality of” an element includes two or more of the claimed element, and does not imply any particular range of number of elements; that is, a plurality of elements can be as few as two elements.

1. A system comprising:
a source (220, 222) of a wide beamwidth projection (203),
an array of detectors (240),
a beam splitter (225) that is configured to provide two projections (201, 202) of the wide beamwidth projection (203):
a first projection (201) that extends across a planar area, and
a second projection (202) that extends across the array of detectors, and
a detection system (250) that is configured to detect interferences caused by reflections of the first projection (201) onto the array of detectors (240), and to determine therefrom a presence of one or more objects (150) in the planar area.

2. The system of claim 1, wherein
the source (220, 222) provides a wide beamwidth laser projection.

3. The system of claim 1, wherein
the source (220, 222) includes a cylindrical lens (222) that provides the wide beamwidth projection.

4. The system of claim 1, including
a lens system (315) that is configured to direct the reflections of the first projection (301) onto the array of detectors (312).

5. The system of claim 4, wherein
the lens system (315) is configured to direct the reflections of rays (201b) of the first projection (201) to areas (240b) of the array of detectors (240) where corresponding rays (202b) of the second projection (202) strike the array of detectors (240).

6. The system of claim 1, wherein
the detection system (250) is configured to determine a location of at least one of the objects (150) relative to the planar area.

7. The system of claim 6, wherein
the detection system (250) is configured to determine the location based on the interferences detected from a plurality of detectors of the array (240).

8. The system of claim 6, wherein
the detection system (250) is configured to determine the location based on multiple measures of the interferences over time.

9. The system of claim 1, including
a display screen (300) adjacent the planar area.

10. The system of claim 1, wherein
the detection system (250) is configured to control an energy level associated with the projections.

11. A method comprising:
providing (220, 222) a wide beamwidth projection,
splitting (225) the wide beamwidth projection to provide two projections:
a first projection (201) that extends across a planar area, and
a second projection (202) that extends across an array of detectors (240),
detecting (240) interferences caused by reflections of the first projection onto the array of detectors, and
determining (250) from the interferences a presence of one or more objects (150) in the planar area.

12. The method of claim 11, wherein
the wide beamwidth projection includes a laser projection (220).

13. The method of claim 11, including
providing (220, 222) the wide beamwidth projection includes spreading (222) a narrowbeam projection via a cylindrical lens that provides the wide beamwidth projection

14. The method of claim 11, including
directing the reflections of the first projection onto the array of detectors (312) via a lens system (315).

15. The method of claim 14, wherein
rays (201b) of the reflections of the first projection (201) are directed to strike the array of detectors (240) at areas (240b) where corresponding rays (202b) of the second projection (202) strike the array of detectors (240).

16. The method of claim 11, including
determining (250) a location of at least one of the objects (150) relative to the planar area.

17. The method of claim 16, wherein
determining (250) the location includes determining the location based on the interferences detected from a plurality of detectors of the array (240).

18. The method of claim 16, wherein
determining (250) the location includes determining the location based on multiple measures of the interferences over time.

19. The method of claim 11, including
displaying information on a display screen (300) adjacent the planar area.

20. The method of claim 11, including
controlling (250) an energy level associated with the projections.
